(19) United States
(12) Patent Application Publication
(10) Pub. No.: US 2014/0304997 A1
(43) Pub. Date: Oct. 16, 2014

(54) HIGH PRECISION POSITIONING RULER WITH AN INDICATION PEN

(71) Applicant: Ku-Hsi Hu, Taipei (TW)

(72) Inventor: Ku-Hsi Hu, Taipei (TW)

(21) Appl. No.: 13/861,401

(22) Filed: Apr. 12, 2013

(51) Int. Cl. G01B 3/02

(52) U.S. Cl. CPC G01B 3/02
USPC 33/488

(57) ABSTRACT

A high precision positioning ruler with an indication pen includes a ruler body having a longitudinal penetrating hole; a scale for indication of lengths being formed on a surface of the ruler body; a positioning unit being slidable along the longitudinal penetrating hole for being positioned to a point of the scale; the positioning unit having an pen for drawing points or lines to indicate lengths to be measured; a leveler and a verticality mater being installed on the ruler body for controlling the ruler to be positioned horizontally or vertically. In use of the ruler, the ruler resisted against a measuring surface; for horizontal measurement, the user views the leveler to control the horizontalness of the ruler; then the positioning unit being moved along the longitudinal penetrating hole to a desired length and then the pen is used to indicate the point.

### FIELD OF THE INVENTION

The present invention relates to rulers, and in particular to a high precision positioning ruler with an indication pen.

### BACKGROUND OF THE INVENTION

In civil engineering or building, to assure flatness in working, generally, a ruler with a leveler is used to measure a length with a preferred horizontalness. Bubble levelers are widely used in many fields.

In the prior art ruler with a leveler, it is often that the original point cannot be precisely positioned. Errors are found. After measurement, the user must take a pen to indicate the point indicating a desired length. The user uses one hand to hold the ruler and uses another hand to take the pen. As a result, the ruler cannot be precisely positioned to be horizontal, even the pen cannot well draw a point or a line to match the measurement.

### SUMMARY OF THE INVENTION

To achieve above object, the present invention provides a high precision positioning ruler with an indication pen. By the present invention, a magnifying unit provides a precise alignment between an original point of the ruler and an initial point of the measuring length so as to increase the preciseness in measurement. Furthermore, the pen is directly installed on the ruler so the indication is also precise, while in the prior art, another pen is used to indicate measuring point. It is easy to have errors. Moreover, the angle indications on a transparent glass is helpful to draw two lines which has a predetermined included angle without using any protractor, and then the ruler is used to determine desire lengths along the two lines. A handle has a function of retaining the ruler on a measuring object by holding the handle to cause the ruler to tightly resist against a surface. A leveler and a plummet meter have the effects to position the ruler horizontally or vertically. Thus, the ruler of the present invention provides the functions of précising measuring a length and an angle with the conveniences of getting a pen, determination of horizontalness and verticalness and stably holding the ruler in position.

To achieve above object, the present invention provides a high precision positioning ruler with an indication pen, comprising: a ruler body having an oblong shape; the ruler body having a longitudinal penetrating hole along a length wise direction of the ruler body; a scale for indication of lengths being formed on a surface of the ruler body and near one end of the longitudinal penetrating hole for determination of a length; a positioning unit being slidable along the longitudinal penetrating hole for being positioned to a point of the scale; the positioning unit having an pen for drawing points or lines to indicate lengths to be measured; a leveler being installed on the ruler body; the leveler serving for controlling the ruler to be positioned horizontally;

In use of the ruler, the ruler resisted against a measuring surface; for horizontal measurement, the user views the leveler to control the horizontalness of the ruler; then the positioning unit being moved along the longitudinal penetrating hole to a desired length and then the pen is used to indicate the point.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2A is an exploded view of the positioning unit and the press unit of the present invention.

FIG. 2B is an assembly view of the positioning unit and the press unit of the present invention.

FIG. 2C is a cross sectional view of the positioning unit and the press unit of the present invention.

FIG. 3A is a schematic cross sectional view showing the magnifying unit of the present invention.

FIG. 3B is a partial enlarged view showing the magnifying unit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

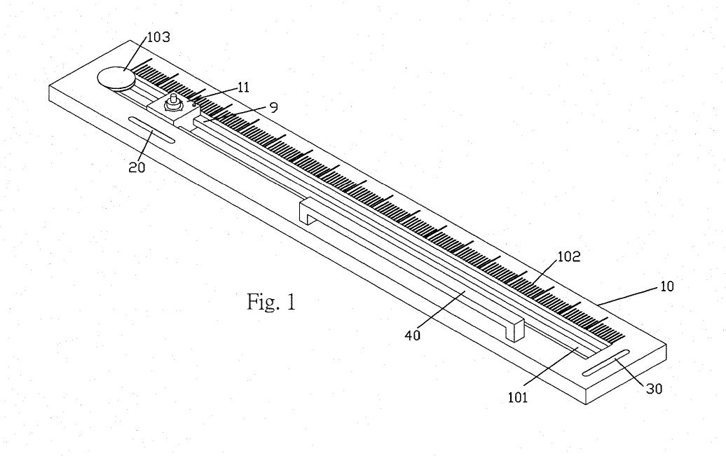

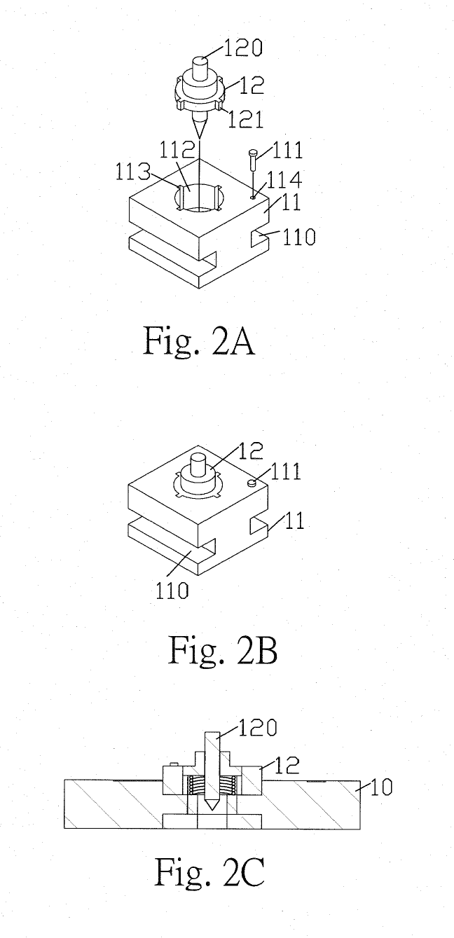

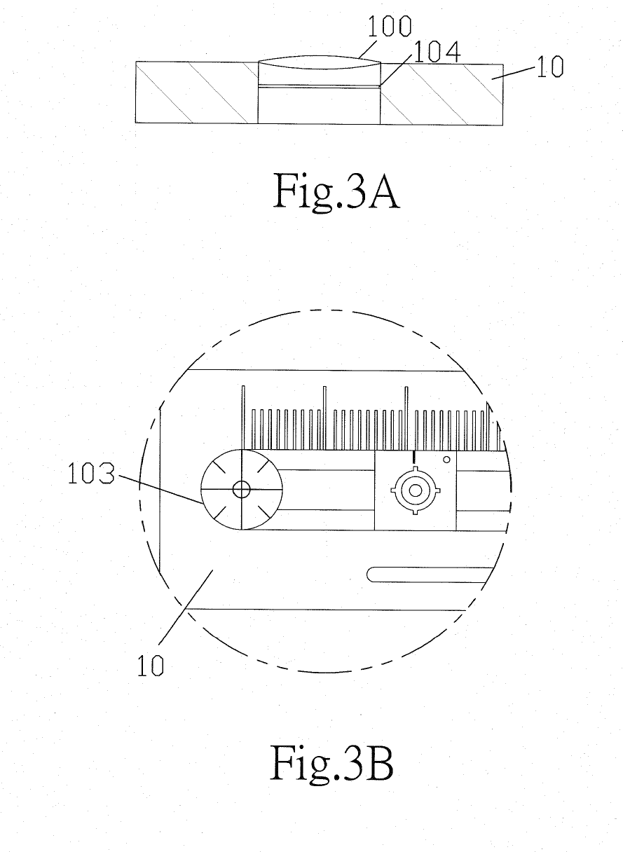

With reference to FIGS. 1 to 3, the structure of the present invention is illustrated. The present invention includes the following elements.

A ruler body 10 has an oblong shape. The ruler body 10 has a longitudinal penetrating hole 101 along a lengthwise direction of the ruler. Each of two inner longitudinal lateral walls of the longitudinal penetrating hole 101 is formed with a protruding track 9. A scale 102 for indication of lengths is formed on a surface of the ruler body 10 and near one edge of the longitudinal penetrating hole 101 for determinations of lengths.

A magnifying unit 103 is installed near one end of the longitudinal penetrating hole 101. The magnifying unit 103 is formed by a magnifying glass 100 and a transparent glass 104. The magnifying unit 103 serves to precisely align an original point of the scale 102 to an initial point of a length to be measured so that the error in measurement is minimized. The transparent glass 104 is formed with a protractor with various angle indications. A cruciform indication is formed on a center of the protractor of the transparent glass 104. The angle indications of the protractor is formed along a ring. In use, the user can have a desire angle by using protractor on the transparent glass 104 so that the ruler can be used to measure along two lines aside the angle.

A positioning unit 11 has an approximate rectangular shape. Each of two lateral sides of the positioning unit 11 is formed with a recess 110. Each recess 110 is engagable to one of the tracks 9 of the longitudinal penetrating hole 101 so that the positioning unit 11 is slidable within the longitudinal penetrating hole 101. A through hole 112 penetrates from an upper surface to a lower surface of the positioning unit 11 and is preferable at a middle section of the upper surface. An inner wall of the through hole 112 is formed with four retaining holes 113 which are distributed at four different sides of the inner wall of the through hole 112. A non-penetrating screw hole 114 is bolted from the upper surface of the positioning unit 11. A retaining screw 111 is installed in the screw hole 114 as screwing the retaining hole 113, the positioning unit 11 will press the track 9 at inner sides of the longitudinal penetrating hole 101 so that the positioning unit 11 will be stably retained within the longitudinal penetrating hole 101.

A press unit 12 passes through the through hole 112. A periphery of the press unit 12 is formed with a plurality of tenons 121. Each tenon is retained within a respective one of the retaining holes 113. The pen 120 penetrates through the press unit 12 from an upper side to a lower side of the press unit 12. As pressing the pen 120, the pen 120 will move downwards to contact a surface at a lower side of the ruler body 10 to draw a point at a contact point of the pen to the surface. A spring is installed between the pen 120 and the press unit 12 to provide a restore force to the pen 120 so that after the pen 120 has drawn a point or a line, it can restore to an original position.

A leveler 20 is installed on the ruler body 10. The leveler 20 serves to control the ruler to be positioned horizontally without tilt.

A plummet meter 30 (or another leveler which is installed to be perpendicular to the leveler 20) is installed on the ruler body 10 for providing the user to determine whether the ruler is vertically arranged.

A handle 40 is formed on an upper surface of the ruler body 10 by which the user can hold the ruler and presses the ruler to resist against a wall.

In use of the present invention, the ruler is resisted against a measuring surface. For horizontal measurement, the user views the leveler 20 to control the horizontalness of the ruler. Then the ruler is positioned to cause an initial point of a measuring length to align with the original point of the scale 102 by using the magnifying unit 103. Then the positioning unit 11 is moved along the longitudinal penetrating hole 101 to a desired length and then the pen 120 draws a point to indicate the measuring length. The processes can be repeated to extend the length to a desired one. To measure verticality, the same process can be used, but the plummet meter 30 is used.

Moreover, if it is desired to measure two lines forming a predetermined included angle, the angle indications of the protractor on the transparent glass 104 is used to determine the two lines aside a desired angle. Then with the same measurement way described above, the ruler of the present invention can be used to indicate the desired lengths on the lines.

Advantage of the present invention is that the magnifying unit 103 provides a precise alignment between the original point of the ruler and the initial point of the measuring length to increase the preciseness in measurement. Furthermore, the pen is directly installed on the ruler so the indication is also precise, while in the prior art, another pen is used to indicate measuring point so that it is easy to have an error. Moreover, the angle indications on the transparent glass is helpful to draw two lines aside a predetermined included angle, and then the ruler is used to determine desire lengths along the two lines. The handle has a function of retaining the ruler on a measuring object by holding the handle to cause the ruler to tightly resist against a surface. The leveler and the plummet meter have the effects to position the ruler horizontally or vertically. Thus, the ruler of the present invention provides the functions of précising measuring a length and an angle with the conveniences of getting a pen, determination of horizontalness and verticality and stably holding the ruler in position.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high precision positioning ruler with an indication pen, comprising:
a ruler body having an oblong shape; the ruler body having a longitudinal penetrating hole along a length wise direction of the ruler body; a scale for indication of lengths being formed on a surface of the ruler body and near one end of the longitudinal penetrating hole for determination of a length;
a positioning unit being slidable along the longitudinal penetrating hole for being positioned to a point of the scale; the positioning unit having an pen for drawing points or lines to indicate lengths to be measured;
a leveler being installed on the ruler body; the leveler serving for controlling the ruler to be positioned horizontally;
wherein in use of the ruler, the ruler resisted against a measuring surface; for horizontal measurement, the user views the leveler to control the horizontalness of the ruler; then the positioning unit being moved along the longitudinal penetrating hole to a desired length and then the pen is used to indicate the point.

2. The high precision positioning ruler with an indication pen as claimed in claim 1, further comprising:
a magnifying unit installed near on edge of the longitudinal penetrating hole; the magnifying unit being formed by a magnifying glass and a transparent glass; the magnifying unit serving for to precisely aligning an original point of the scale to an initial point of a length to be measured so that the error in measurement is minimized;
the transparent glass being formed with angle scales to form as a protractor; a cruciform indication being formed on a center of the scale of the transparent glass; and the angle indications are arranged along a ring.

3. The high precision positioning ruler with an indication pen as claimed in claim 1, wherein
each of two inner longitudinal lateral walls of the longitudinal penetrating hole is formed with a protruding track; and
each of two lateral sides of the positioning unit is formed with a recess; each recess is engagable to the track of the longitudinal penetrating hole so that the positioning unit is slidable within the longitudinal penetrating hole.

4. The high precision positioning ruler with an indication pen as claimed in claim 1, wherein
a through hole penetrates through the positioning unit from an upper surface to a lower surface of the positioning unit; an inner wall of the through hole is formed with a plurality of retaining holes which are distributed at for different sides of the inner wall of the through hole; and
a press unit passes through the through hole of the positioning unit; a periphery of the press unit is formed with a plurality of tenons; each tenon is retained within a respective one of the retaining holes; a pen penetrates through the press unit from an upper side to a lower side thereof; as pressing the pen, the pen will move downwards to contact a surface at a lower side of the ruler body to draw a point or a line on the surface at the lower side of the ruler body.

5. The high precision positioning ruler with an indication pen as, claimed in claim 4, wherein a non-penetrating screw hole is bolted from the upper surface of the positioning unit; a retaining screw is installed in the screw hole; as screwing the retaining hole, the positioning unit will press the protruding track at inner wall of the longitudinal penetrating hole so that the positioning unit will retain within the longitudinal penetrating hole.

6. The high precision positioning ruler with an indication pen as claimed in claim 5, wherein a spring is installed between the pen and the press unit to provide a restore force to the pen so that after the pen has drawn a point or a line, the pen can restore to an original position.

7. The high precision positioning ruler with an indication pen as claimed in claim 1, wherein the ruler has an indication point for aligning with to a point of the scale so that the positioning unit can be precisely positioned.

8. The high precision positioning ruler with an indication pen as claimed in claim 1, further comprising a verticality meter installed on the ruler, body for providing the user to determine whether the ruler is vertically arranged.

9. The high precision positioning ruler with an indication pen as claimed in claim 1, further comprising a handle formed on the ruler body by which the user can hold the ruler and presses the ruler to resist against a wall.
